(19) United States
(12) Patent Application Publication
(10) Pub. No.: US 2026/0340375 A1
(43) Pub. Date: Oct. 29, 2026

(54) UPDATING MACHINE LEARNING MODEL FOR POSITIONING

(71) Applicant: Nokia Technologies Oy, Espoo (FI)

(72) Inventors: Oana-Elena BARBU, Aalborg (DK); Diomidis MICHALOPOULOS, Munich (DE); Muhammad Ikram ASHRAF, Espoo (FI); Athul PRASAD, Naperville, IL (US); Sajad REZAIE, Aalborg (DK)

(21) Appl. No.: 18/997,371

(22) PCT Filed: Aug. 18, 2022
(86) PCT No.: PCT/US2022/075117

§ 371 Date: Jan. 21, 2025

(51) Int. Cl. G06N 3/08; H04L 41/16; H04W 64/00

(52) U.S. Cl. CPC G06N 3/08; H04L 41/16; H04W 64/006

(57) ABSTRACT

Disclosed is a method comprising obtaining a machine learning model for positioning, wherein the machine learning model is trained based on first training data related to one or more first network nodes; transmitting information including at least one of the following: the machine learning model, a request for updating the machine learning model based on second training data, or a request for providing the second training data for updating the machine learning model at the apparatus; receiving at least one of the following: a message indicative of an updated machine learning model, or the second training data; and transmitting the updated machine learning model at least to one or more second network nodes.

### FIELD

The following example embodiments relate to wireless communication and to updating a machine learning model for positioning.

### BACKGROUND

Positioning technologies may be used to estimate a physical location of a device. It is desirable to improve the positioning accuracy in order to estimate the location of the device more accurately.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions which, when executed by the at least one processor, cause the apparatus at least to: obtain a machine learning model for positioning, wherein the machine learning model is trained based on first training data related to one or more first network nodes; transmit information including at least one of the following: the machine learning model, a request for updating the machine learning model based on second training data, or a request for providing the second training data for updating the machine learning model at the apparatus; receive at least one of the following: a message indicative of an updated machine learning model, or the second training data; and transmit the updated machine learning model at least to one or more second network nodes.

According to another aspect, there is provided an apparatus comprising: means for obtaining a machine learning model for positioning, wherein the machine learning model is trained based on first training data related to one or more first network nodes; means for transmitting information including at least one of the following: the machine learning model, a request for updating the machine learning model based on second training data, or a request for providing the second training data for updating the machine learning model at the apparatus; means for receiving at least one of the following: a message indicative of an updated machine learning model, or the second training data; and means for transmitting the updated machine learning model at least to one or more second network nodes.

According to another aspect, there is provided a method comprising: obtaining, by an apparatus a machine learning model for positioning, wherein the machine learning model is trained based on first training data related to one or more first network nodes; transmitting, by the apparatus, information including at least one of the following: the machine learning model, a request for updating the machine learning model based on second training data, or a request for providing the second training data for updating the machine learning model at the apparatus; receiving, by the apparatus, at least one of the following: a message indicative of an updated machine learning model, or the second training data; and transmitting, by the apparatus, the updated machine learning model at least to one or more second network nodes.

According to another aspect, there is provided a computer program comprising instructions which, when executed by an apparatus, cause the apparatus to perform at least the following: obtaining a machine learning model for positioning, wherein the machine learning model is trained based on first training data related to one or more first network nodes; transmitting information including at least one of the following: the machine learning model, a request for updating the machine learning model based on second training data, or a request for providing the second training data for updating the machine learning model at the apparatus; receiving at least one of the following: a message indicative of an updated machine learning model, or the second training data; and transmitting the updated machine learning model at least to one or more second network nodes.

According to another aspect, there is provided a computer readable medium comprising program instructions which, when executed by an apparatus, cause the apparatus to perform at least the following: obtaining a machine learning model for positioning, wherein the machine learning model is trained based on first training data related to one or more first network nodes; transmitting information including at least one of the following: the machine learning model, a request for updating the machine learning model based on second training data, or a request for providing the second training data for updating the machine learning model at the apparatus; receiving at least one of the following: a message indicative of an updated machine learning model, or the second training data; and transmitting the updated machine learning model at least to one or more second network nodes.

According to another aspect, there is provided a non-transitory computer readable medium comprising program instructions which, when executed by an apparatus, cause the apparatus to perform at least the following: obtaining a machine learning model for positioning, wherein the machine learning model is trained based on first training data related to one or more first network nodes; transmitting information including at least one of the following: the machine learning model, a request for updating the machine learning model based on second training data, or a request for providing the second training data for updating the machine learning model at the apparatus; receiving at least one of the following: a message indicative of an updated machine learning model, or the second training data; and transmitting the updated machine learning model at least to one or more second network nodes.

According to another aspect, there is provided an apparatus comprising at least one processor, and at least one memory storing instructions which, when executed by the at least one processor, cause the apparatus at least to: receive information including at least one of the following: a machine learning model for positioning, a request for updating the machine learning model at the apparatus based on second training data, or a request for providing the second training data for updating the machine learning model, wherein the machine learning model has been trained based on first training data related to one or more first network nodes; obtain the second training data; and transmit at least one of the following: a message indicative of an updated machine learning model, or the second training data.

According to another aspect, there is provided an apparatus comprising: means for receiving information including at least one of the following: a machine learning model for positioning, a request for updating the machine learning model at the apparatus based on second training data, or a request for providing the second training data for updating the machine learning model, wherein the machine learning model has been trained based on first training data related to one or more first network nodes; means for obtaining the second training data; and means for transmitting at least one of the following: a message indicative of an updated machine learning model, or the second training data.

According to another aspect, there is provided a method comprising: receiving, by an apparatus, information including at least one of the following: a machine learning model for positioning, a request for updating the machine learning model at the apparatus based on second training data, or a request for providing the second training data for updating the machine learning model, wherein the machine learning model has been trained based on first training data related to one or more first network nodes; obtaining, by the apparatus, the second training data; and transmitting, by the apparatus, at least one of the following: a message indicative of an updated machine learning model, or the second training data.

According to another aspect, there is provided a computer program comprising instructions which, when executed by an apparatus, cause the apparatus to perform at least the following: receiving information including at least one of the following: a machine learning model for positioning, a request for updating the machine learning model at the apparatus based on second training data, or a request for providing the second training data for updating the machine learning model, wherein the machine learning model has been trained based on first training data related to one or more first network nodes; obtaining the second training data; and transmitting at least one of the following: a message indicative of an updated machine learning model, or the second training data.

According to another aspect, there is provided a computer readable medium comprising program instructions which, when executed by an apparatus, cause the apparatus to perform at least the following: receiving information including at least one of the following: a machine learning model for positioning, a request for updating the machine learning model at the apparatus based on second training data, or a request for providing the second training data for updating the machine learning model, wherein the machine learning model has been trained based on first training data related to one or more first network nodes; obtaining the second training data; and transmitting at least one of the following: a message indicative of an updated machine learning model, or the second training data.

According to another aspect, there is provided a non-transitory computer readable medium comprising program instructions which, when executed by an apparatus, cause the apparatus to perform at least the following: receiving information including at least one of the following: a machine learning model for positioning, a request for updating the machine learning model at the apparatus based on second training data, or a request for providing the second training data for updating the machine learning model, wherein the machine learning model has been trained based on first training data related to one or more first network nodes; obtaining the second training data; and transmitting at least one of the following: a message indicative of an updated machine learning model, or the second training data.

### LIST OF DRAWINGS

In the following, various example embodiments will be described in greater detail with reference to the accompanying drawings, in which

FIG. 1 illustrates an example of a cellular communication network;

FIG. 2 illustrates an example of a positioning scenario;

FIG. 3 illustrates a signaling diagram according to an example embodiment;

FIG. 4 illustrates a signaling diagram according to an example embodiment;

FIG. 5 illustrates a flow chart according to an example embodiment;

FIG. 6 illustrates a flow chart according to an example embodiment;

FIG. 7 illustrates an example of an apparatus;

FIG. 8 illustrates an example of an apparatus;

FIG. 9 illustrates an example of an apparatus;

FIG. 10 illustrates an example of an artificial neural network; and

FIG. 11 illustrates an example of a computational node.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

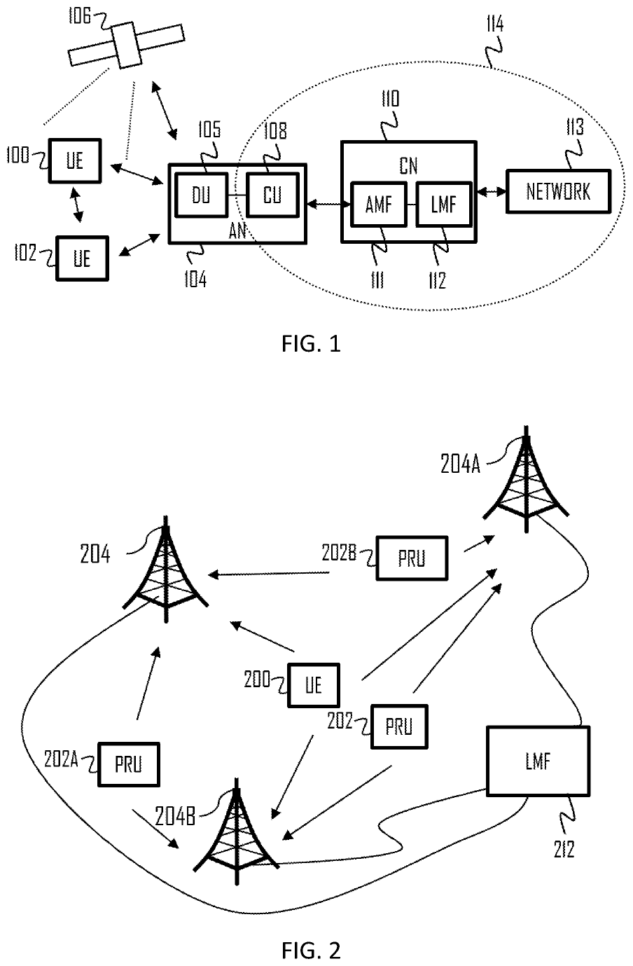

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node (AN) 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes and also for routing data from one access node to another. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the deployed technology, the counterpart that the access node may be connected to on the CN side may be a serving gateway (S-GW, routing and forwarding user data packets), packet data network gateway (P-GW) for providing connectivity of user devices to external packet data networks, user plane function (UPF), mobility management entity (MME), or an access and mobility management function (AMF), etc.

With respect to positioning, the service-based architecture (core network) may comprise an AMF 111 and a location management function (LMF) 112. The AMF may provide location information for call processing, policy, and charging to other network functions in the core network and to other entities requesting for positioning of terminal devices. The AMF may receive and manage location requests from several sources: mobile-originated location requests (MO-LR) from the user devices and mobile-terminated location requests (MT-LR) from other functions of the core network or from other network elements. The AMF may select the LMF for a given request and use its positioning service to trigger a positioning session. The LMF may then carry out the positioning upon receiving such a request from the AMF. The LMF may manage the resources and timing of positioning activities. The LMF may use a Namf_Communication service on an NL1 interface to request positioning of a user device from one or more access nodes, or the LMF may communicate with the user device over N1 for UE-based or UE-assisted positioning. The positioning may include estimation of a location and, additionally, the LMF may also estimate movement or accuracy of the location information when requested. Connection-wise, the AMF may be between the access node and the LMF and, thus, closer to the access nodes than the LMF.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cm Wave and mm Wave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with one or more other networks 113, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or the like, providing facilities for networks of different operators to cooperate for example in spectrum sharing.

An access node may also be split into: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be defined as a logical node hosting higher layer protocols, such as radio resource control (RRC), service data adaptation protocol (SDAP) and/or packet data convergence protocol (PDCP), of the access node. The DU 105 may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU 108 and/or DU 105. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of functions between the above-mentioned access node units, or different core network operations and access node operations, may differ.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It is also possible that node operations may be distributed among a plurality of servers, nodes or hosts. Application of cloudRAN architecture enables RAN real-time functions being carried out at the RAN side (e.g., in a DU 105) and non-real-time functions being carried out in a centralized manner (e.g., in a CU 108).

It should also be understood that the distribution of functions between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). A given satellite 106 in the mega-constellation may cover several satellite-enabled network entities that create on-ground cells. The on-ground cells may be created through an on-ground relay node or by an access node 104 located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

Positioning technologies may be used to estimate a physical location of a user device. Herein the user device to be positioned is referred to as a target UE or target user device. For example, the positioning techniques used in NR may be based on at least one of the following: time difference of arrival (TDoA), time of arrival (TOA), time of departure (TOD), round trip time (RTT), angle of departure (AoD), angle of arrival (AoA), and/or carrier phase.

In Uu positioning (UL/DL positioning), multiple transmission and reception points (TRPs) in known locations may transmit and/or receive one or more positioning reference signals (PRS) to/from the target UE. In the uplink, a sounding reference signal (SRS) may be used as a positioning reference signal. For example, multilateration techniques may then be used to localize (i.e., position) the target UE with respect to the TRPs. One TRP out of these TRPs may be used as a positioning anchor, and the differences in TDoA may be computed with respect to this positioning anchor. The positioning anchor may also be referred to as an anchor, anchor node, multilateration anchor, or reference point herein.

Sidelink (SL) positioning refers to the positioning approach, where the target UE utilizes the sidelink (i.e., the direct device-to-device link) to position itself, either in an absolute manner (in case of absolute positioning) or in a relative manner (in case of relative positioning). For UE-assisted positioning (in SL positioning and Uu positioning), the target UE may utilize the sidelink to obtain positioning measurements and report the measurements to a network entity such as a location management function (LMF). Sidelink positioning may also be used to obtain ranging information.

Ranging means determination of the distance between two UEs and/or the direction of one UE from the other one via direct device connection.

Absolute positioning means estimating the position of the target UE in two-dimensional or three-dimensional geographic coordinates (e.g., latitude, longitude, and/or elevation) within a coordinate system.

Relative positioning means estimating the position of the target UE relative to other network elements or relative to other UEs.

SL positioning may be based on the transmission of a sidelink positioning reference signal (SL PRS) by multiple anchor UEs (anchor user devices), wherein the SL PRS is received and measured by a target UE to enable localization of the target UE within precise latency and accuracy requirements of the corresponding SL positioning session. Alternatively, or additionally, the target UE may transmit SL PRS to be received and measured by the anchor UEs.

An anchor UE may be defined as a UE supporting positioning of the target UE, for example by transmitting and/or receiving reference signals (e.g., SL PRS) for positioning over the SL interface. This may be similar to UL/DL-based positioning, where gNBs may serve as anchors transmitting and/or receiving reference signals to/from target UEs for positioning.

SL PRS refers to a reference signal transmitted over SL for positioning purposes.

Furthermore, positioning reference units (PRUs) may be used in the positioning session for increasing the positioning accuracy for positioning the target UE. PRUS are reference devices at known locations, which are taking measurements that are used to generate correction data that may be used to refine the location estimate of a target UE in the area, thereby increasing the positioning accuracy for positioning the target UE. For example, a UE with a known location may be used as a PRU.

A PRU at a known location may perform positioning measurements, such as reference signal time difference (RSTD), reference signal received power (RSRP), UE reception-transmission time difference measurements, etc., and report these measurements to a location server such as an LMF. In addition, the PRU may transmit an UL SRS for positioning to enable TRPs to measure and report UL positioning measurements (e.g., relative time of arrival, UL-AoA, gNB reception-transmission time difference, etc.) from PRUs at a known location. The PRU measurements may be compared by the location server with the measurements expected at the known PRU location to determine correction data for other nearby target UE(s). The DL and/or UL location measurements for other target UE(s) can then be corrected based on the previously determined correction data.

PRUs may also serve as positioning anchors for the target UE, or they may just provide correction data (e.g., to LMF) to help with positioning the target UE.

In other words, PRUs located at known locations may act as reference target UEs, such that their calculated position is compared with their known location. The comparison of the known and estimated location may result in correction data, which can be used for the location estimation process of other target UEs in the vicinity, under the assumption that the same or similar accuracy determination effects apply to both the location of the PRU and the location of the other target UEs. Then, the correction data may be used for fine-tuning the location estimate of the target UEs, thereby increasing the positioning accuracy.

The location of a target UE can be calculated either at the network, for example at the LMF (in the case of LMF-based positioning), or at the target UE itself (in the case of UE-based positioning). The measurements for positioning can be carried out either at the UE side (e.g., in case of DL or SL positioning) or at the network side (e.g., in case of UL positioning).

FIG. 2 illustrates an example, where one or more PRUs 202, 202A, 202B are used for positioning a target UE 200. The PRUs may be configured to transmit reference signals that are measured for the purpose of positioning the target UE 200. The target UE 200 may further transmit a reference signal for the purpose of positioning the target UE 200. One or more access nodes 204, 204A, 204B may measure the reference signals received from the PRU(s) 202, 202A, 202B and from the target UE 200. In case of sidelink positioning, the target UE 200 may measure reference signals received from the PRU(s) 202, 202A, 202B, and/or the PRU(s) 202, 202A, 202B may measure reference signals received from the target UE and/or from other UEs or PRUs. Measured parameters (measurement data) derived from the received reference signals may include a reference signal reception time, reference signal time difference (RSTD), reference signal angle-of-arrival, and/or RSRP, for example. The measurement data may be reported to a network element acting as a location management function (LMF) 212 configured to carry out the positioning on the basis of the measurement data. The LMF 212 may estimate a location of the target UE 200 on the basis of the received measurement data and the known locations of the PRU(s) measured by the reporting access node(s). For example, location estimation functions used in real-time kinematic positioning (RTK) applications of global navigation satellite systems may be employed. As an example, if the measurements indicate that signals received from the target UE 200 and one of the PRU(s) 202 have high correlation, the location of the target UE 200 may be estimated to be close to that PRU 202 and further away from the other PRUs 202A, 202B. A correction from the location of a given PRU 202A, 202B may be computed on the basis of the measurement data, for example by using the difference between the measurement data associated with the target UE 200 and the measurement data associated with the closest PRU 202. For example, multi-lateration measurements (multiple measurements of the RSRP, RSTD, and/or other parameters) may indicate that the target UE 200 is to a certain direction from the closest PRU 202, and the correction may be made to that direction.

The NR air interface may be augmented with features enabling support for artificial intelligence (AI) and/or machine learning (ML) based algorithms for enhanced performance and/or reduced complexity and overhead. Some use cases for such AI/ML techniques may include (but are not limited to) channel state information (CSI) feedback enhancement (e.g., overhead reduction, improved accuracy, prediction), beam management (e.g., beam prediction in time and/or spatial domain for overhead and latency reduction, beam selection accuracy improvement), and positioning accuracy enhancements (e.g., in scenarios with heavy non-line-of-sight, positioning reference signaling and measurement reporting overhead reduction, positioning accuracy with availability of limited labelled data, scenarios with devices having significant RF impairments/imperfections impacting positioning measurement, etc.).

Using AI/ML techniques for positioning accuracy enhancements may involve that the training for positioning purposes is carried out at a central ML unit, such as a location management function (LMF) or a 5G network data analytics function (NWDAF). The NWDAF may run data analytics to generate insights and take action to enhance user experience, including positioning use cases.

The training of an ML model at the central ML unit may be done, for example, according to the following process (described in steps 1-4 below):
1) A set of data collection devices may be deployed in chosen locations. Alternatively, the data collection devices may be selected randomly from a given geographical region. For example, these data collection devices may be PRUs. In the following, the data collection devices are referred to as PRUs for simplicity, although any other type of data collection device may also be used instead of PRUs.
2) The PRUs conduct field positioning measurements and report the measurements to the central ML unit.
3) The central ML unit uses emulation tools to generate (emulated) positioning measurements. It should be noted that step 3 may be performed instead of or in addition to step 2.
4) The central ML unit uses the above positioning measurements (the reported measurements and/or the emulated measurements) to train a generic ML-based localization framework. Herein this generic ML-based localization framework is denoted as GLoc.

The trained GLoc may then be deployed at network nodes running ML processes and/or algorithms. Such network nodes are referred to as hosts herein. The hosts may be of different types, wherein a type may be defined in relation to the host's radio frequency (RF) and/or baseband capabilities, form factor, or target positioning key performance indicators (KPIs). Hosts carrying out ML processes may be, for example, the target UE, the PRUs, and the radio access network (e.g., gNB, TRP, and/or location management component, LMC) to enhance the positioning accuracy.

However, a problem with the generic ML-based localization framework (GLoc) is that it does not account for specific RF limitations (also referred to as RF imperfections) of the deployed host types (e.g., handheld UE, road-side unit, or gNB). The RF limitations/imperfections may be dependent on the hardware limitations of the different antenna configurations and form factors, analog-to-digital conversion (ADC) resolutions, crystal oscillators, etc. The various RF imperfections may introduce a combination of: carrier frequency offset, sampling time offset, transmit/receive beam offsets, clock offsets and drifts, phase noise, etc.

These RF imperfections may translate into additional phase rotation and delays of the positioning signal by the RF chain, as observed at the baseband receiver. As a result, a positioning entity (e.g., UE, TRP, etc.) hosting the GLoc framework may experience certain RF-based signal delays/rotations, which are not taken into account in the GLoc, and are incorrectly absorbed into the positioning measurement. Such imperfections may be different for different host types. For example, a PRU, UE or gNB hosting GLoc would require adapting the GLoc to their own RF-specific characteristics.

Thus, currently there may be no one-size-fits-all GLoc framework that would meet, for example, the high positioning accuracy requirements of NR Release 18 at cm-level. As such, a device of a given host type may need to adapt the GLoc to its own RF characteristics, such as antenna form factors and configurations.

Some example embodiments are described below using principles and terminology of 5G NR technology without limiting the example embodiments to 5G NR communication systems, however.

Some example embodiments may address the above problem by providing a method, which tailors the generic GLoc framework for host-type-specific ML positioning. In other words, some example embodiments may be used to adapt a generic machine learning model (e.g., trained using training data collected from NR elements of different types) to a machine learning model adapted to compensate for intrinsic errors, which are specific to a given host type. Thus, some example embodiments may provide positioning accuracy enhancements using AI/ML techniques.

Meta-learning in the context of AI/ML refers to tailoring a generic model (e.g., trained using features extracted from heterogeneous sources) to a specific type of entity and/or task. A sub-branch of meta-learning is transfer learning (TL). TL targets to adjust an already trained model to perform the same task but on a different entity type.

Some example embodiments may provide a TL framework for positioning, through which the generic GLoc framework for positioning may be customized to the specific NR element host types. More specifically, before the GLoc framework is deployed on a large scale, the GLoc may be refined based on at least intrinsic characteristics (e.g., RF limitations) of the NR element types (e.g., target UE, PRU, or gNB).

Some example embodiments allow the central ML unit (e.g., LMF) to select an NR head unit (NR-HU) as a representative for a given NR element type, and thus for a given expected intrinsic distortion range. Then, the GLoc model may be refined by or with help of NR-HUs such that it is customized to compensate for the distortion specific to that NR element type.

To perform the model adaptation, the central ML unit may provide, to the NR-HU, the generic GLoc framework together with the parameters (such as capabilities and RF imperfections of the devices that were used to generate the GLoc) considered to obtain such a framework, as well as the corresponding training procedure.

The generic GLoc may then be refined based on the NR-HU's individual type (e.g., capabilities and RF imperfections). Lastly, the adapted model may be reported to the central ML unit, along with a reasoning behind refining the process as such. Based on such reasoning, the central ML unit may iteratively further refine or validate the GLoc framework and provide the next refined version to the host entities.

As one example, a GLoc trained using UL SRS collected by TRPs may be tailored to static UEs, by using as input the DL PRS as observed at the static UE baseband. The refined model, called static-UE-GLoc may be transferred back to the LMF, which then distributes it to other static UEs.

As another example, a GLoc trained using UL SRS collected by TRPs may be tailored to high-speed UEs.

As another example, a GLoc trained in an outdoor environment may be tailored to an indoor environment to provide a refined model called indoor-GLoc.

As another example, a GLoc trained on samples collected from an urban scenario may be tailored to a suburban scenario to provide a refined model called suburban-GLoc.

The training at NR-HU may be beneficial, since the host (NR-HU) collects signals distorted similarly to other NR elements of the same type. The TL by NR-HU may be based on the fact that the intrinsic signal distortion is inherent to the positioning signals that the NR-HU collects, and that the NR-HU uses a type-specific cost function to refine the GLoc, as well as type-specific model constraints (e.g., depth of the artificial or simulated neural network, available activation functions, etc.).

Alternatively, or additionally, the central ML unit may request the NR-HU to collect, timestamp and transfer its training data to the central ML unit, and specify its model constraints (if any), in order to refine the GLoc at the central ML unit.

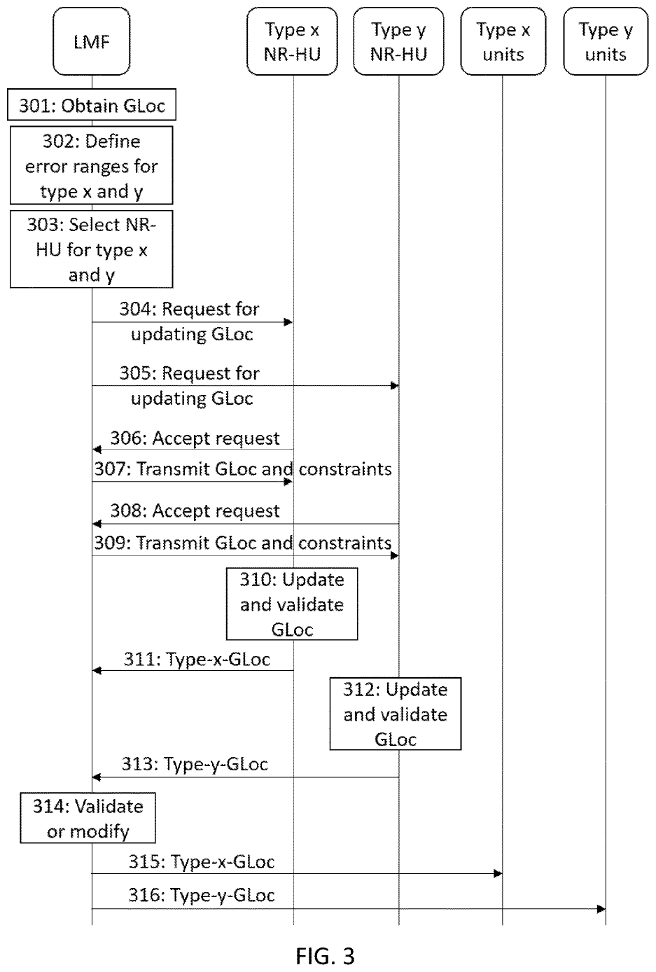

FIG. 3 illustrates a signaling diagram according to an example embodiment. Although two types (type x and type y) of network nodes are illustrated in FIG. 3, it should be noted the that the number of types may also be different than two. In other words, there may be one or more types of network nodes. In addition, the signaling procedure illustrated in FIG. 3 may be extended and applied according to the actual number of types. The central ML unit (e.g., LMF) may determine the actual number of types depending on the ability to group various network nodes based on their RF characteristics.

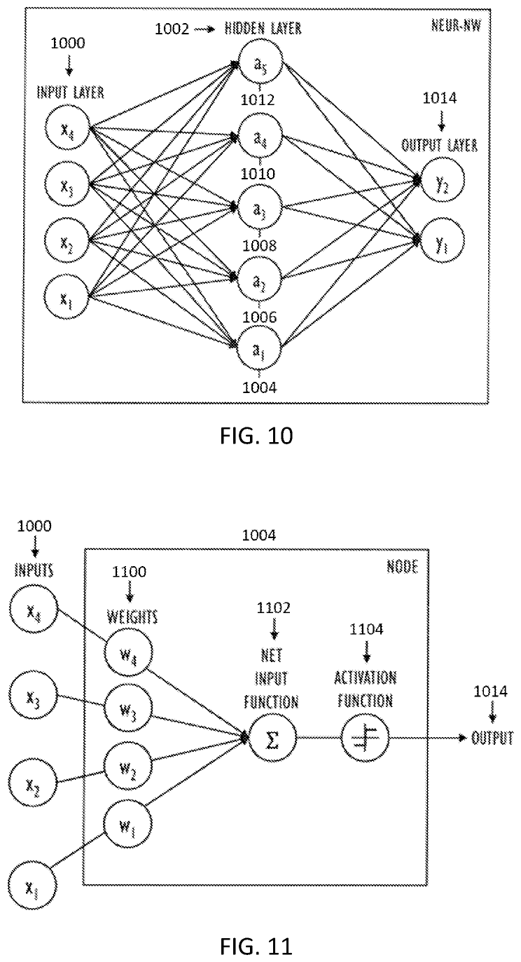

Referring to FIG. 3, in block 301, a central ML unit such as an LMF obtains a machine learning model for positioning, wherein the machine learning model is trained based on first training data related to one or more first network nodes. The machine learning model may be trained for positioning, or for a similar task that may also be used for positioning. The LMF may obtain the machine learning model by training the model at the LMF. Alternatively, the machine learning model may be trained at another entity, from which the LMF may receive the machine learning model. The machine learning model may be referred to as GLoc herein. For example, the machine learning model may comprise an artificial neural network (ANN). An example of an artificial neural network is illustrated in FIG. 10.

The first training data may comprise at least one of the following: reference signal measurement information measured at the one or more first network nodes from one or more received positioning reference signals (e.g., DL PRS, UL SRS, and/or SL PRS), emulated reference signal measurement information, or simulated reference signal measurement information related to the one or more first network nodes. For example, the reference signal measurement information may comprise at least channel impulse response (CIR) measurements, which may be simulated or measured at the one or more first network nodes from one or more received positioning reference signals. The emulated reference signal measurement information may be obtained, for example, by using emulation tools such as ray tracing, digital twin, etc.

The one or more first network nodes may comprise one or more types of network nodes. In one example, the one or more first network nodes may comprise a plurality of network nodes of different types.

In block 302, the LMF defines error ranges for type x and type y. The error ranges may indicate the internal timing errors that occurred during the measurement collection, due to RF imperfections or impairments. For example, a transmit timing error may indicate time delay from the time when the digital signal is generated at baseband to the time when the RF signal is transmitted from the transmit antenna. Receive timing error may indicate the time delay from the time when the RF signal arrives at the receive antenna to the time when the signal is digitized and time-stamped at the baseband. The error ranges may be defined by the LMF in order to classify the network nodes into type x and type y. For example, a type x host may be associated with an error range-x of +/−a ns, (e.g., a=5 ns).

In block 303, the LMF selects a third network node of type x (denoted as type x NR-HU) that will perform the transfer learning, i.e., update/refine the machine learning model (generic GLoc) to take into account the RF imperfections specific to type x. The type of the third network node may be different to the type of the one or more first network nodes.

Thus, a single type x NR-HU may be selected as a representative for all type x network nodes, and this single type x NR-HU may perform the model adaptation. This limits the computational complexity and signaling overhead of the transfer learning, by avoiding a scheme in which each type x network node would independently perform the model adaptation.

The LMF may also select a fourth network node of type y (denoted as type y NR-HU) that will update/refine the generic GLoc to take into account the RF imperfections specific to type y. Herein type y may refer to a type that is different to type x.

Herein the term “network node” may mean, for example, a target user device, a positioning reference unit, anchor user device, TRP, or an access node (e.g., gNB) of a radio access network.

Herein the term “type” may mean, for example, a vendor-specific user device, a vendor-specific access node (e.g., gNB), a TRP with certain RF characteristics, a user device with a certain number of receive antennas, an industrial internet of things (IIoT) device, a low-power high-accuracy positioning (LPHAP) device, a reduced capability (RedCap) device, a handheld user device, or a road-side unit (RSU). For example, a type N may be a UE with N receive antennas, where for example type 1 may be a UE with 1 receive antenna, type 2 may be a UE with two receive antennas, etc. The type may be defined in relation to both the target positioning accuracy and the inherent error ranges that a given network node of that type is expected to introduce.

In block 304, the LMF transmits, to the third network node (type x NR-HU), a request for updating the machine learning model at the third network node based on second training data (i.e., a request for assisting with the transfer learning). For example, the request may be transmitted in an information element of an LTE positioning protocol (LPP) request message. The third network node may accept or reject the request from the LMF based on the load condition and/or hardware limitations of the third network node.

The request may comprise information about the configuration of the machine learning model, which is to be updated. For example, such information may define the following: the output and cost function of the machine learning model (i.e., model functionality), type, size and shape of the input of the machine learning model, and the architecture of the machine learning model.

As a non-limiting example, the output of the machine learning model may be time of arrival (TOA) information to be used for positioning, and the cost function may be mean squared error (MSE).

As a non-limiting example, the input of the machine learning model may be a certain number of the strongest channel impulse response (CIR) complex gains.

As a non-limiting example, the architecture of the machine learning model may refer to a deep neural network (DNN) with N=10 hidden layers and the activation function being a rectified linear unit (ReLU).

In block 305, the LMF transmits, to the fourth network node (type y NR-HU), a request for updating the machine learning model at the fourth network node based on third training data. For example, the request may be transmitted in an information element of an LPP request message. The fourth network node may accept or reject the request from the LMF based on the load condition and/or hardware limitations of the fourth network node.

The request may comprise information about the configuration of the machine learning model, which is to be updated. For example, such information may define the following: the output and cost function of the machine learning model (i.e., model functionality), type, size and shape of the input of the machine learning model, and the architecture of the machine learning model.

In other words, in blocks 304 and 305, the LMF requests to configure NR-HUs of different types, which are relevant to processing a specific positioning request.

In block 306, the third network node (type x NR-HU) transmits a response message to the LMF to accept the request. For example, the acceptance may be indicated in an information element of an LPP reply message comprising a yes or no flag, or a conditional yes in which a model constraint is described. For example, the constraint may mean that the type x NR-HU may support a different maximum architecture than the one configured for the GLoc. For example, the reply may comprise: “model_constraint=Model architecture: DNN with N=4 hidden” to indicate that the type x NR-HU supports a DNN with a maximum of 4 hidden layers, whereas the GLoc architecture may comprise a DNN with 10 hidden layers, for example.

In block 307, the LMF transmits, or transfers, the machine learning model to the third network node (type x NR-HU) in response to the third network node accepting the request. This transmission may indicate at least one of the following: a structure of the machine learning model, one or more activation functions of the machine learning model, a set of weights per layer of the machine learning model, a set of biases per layer of the machine learning model, a cost function used to train the machine learning model, input type and format of the machine learning model (i.e., how the input is arranged and what it corresponds to), and/or output type and format of the machine learning model (e.g., probability vector or binary vector, vector length, etc.).

The input of the machine learning model may comprise at least one of the following: received signal samples per receive beam for a total number of beams (where some of the entries may be zero-padded in case they are not available), reference signal received power (RSRP) per positioning source and/or per beam, a line-of-sight (LOS) indication or probability per positioning source, etc. For example, the input may be a vector of CIRs with a certain length, and entries arranged in decreasing order of magnitude.

For example, the output may be time of arrival (TOA) information represented as a real-valued scalar.

The LMF may also transmit information indicative of a set of constraints for updating the machine learning model at the third network node. This way, the LMF may at least partly parameterize the transfer-learning procedure at the third network node. As an example, the set of constraints may indicate at least one of the following: to update the machine learning model using reference signals from a selected physical resource block (PRB) pool, for a given time duration, and/or if certain conditions are fulfilled. For example, the conditions may be fulfilled, if the third network node deems itself as being static, not interfered, etc. Alternatively, or additionally, the set of constraints may indicate to freeze a part of the machine learning model and update the remaining architecture, for example to update weights from layer L onwards.

The LMF may also transmit information on a reference training procedure for updating the machine learning model at the third network node. As an example, the reference training procedure may correspond to using training data collected from multiple network nodes. The information on the reference learning procedure may thus comprise at least a set of parameters (e.g., capabilities and RF imperfections) used for structuring the reference training procedure, which can be considered by the third network node, when refining it based on its own capabilities and imperfections.

In block 308, the fourth network node (type y NR-HU) transmits a response message to the LMF to accept the request. For example, the acceptance may be indicated in an information element of an LPP reply message comprising a yes or no flag, or a conditional yes in which a model constraint is described.

In block 309, the LMF transmits, or transfers, the machine learning model to the fourth network node (type y NR-HU) in response to the fourth network node accepting the request. The LMF may also transmit information indicative of a set of constraints for updating the machine learning model at the fourth network node. The LMF may also transmit information on a reference training procedure for updating the machine learning model at the fourth network node, wherein the information on the reference training procedure comprises at least a set of parameters used for structuring the reference training procedure.

The contents of the transmission of block 309 may be similar as described above for block 307.

In block 310, the third network node (type x NR-HU) obtains a first updated machine learning model by updating the machine learning model (i.e., the original GLoc) based on the second training data. The updating may mean adjusting, refining, or re-training the machine learning model based on the second training data specific to the third network node of type x. The third network node may also validate the first updated machine learning model. The first updated machine learning model obtained by the third network node may be referred to as a type-x-GLoc herein.

The second training data may comprise reference signal measurement information measured at the third network node from one or more received positioning reference signals (e.g., DL PRS, UL SRS, and/or SL PRS), wherein the third network node may be different to the one or more first network nodes. For example, the reference signal measurement information may comprise at least channel impulse response (CIR) measurements measured at the third network node from one or more received positioning reference signals.

The updating of the machine learning model may comprise the followings steps 1-6:
1) Initializing the machine learning model using the one received from the LMF. The initialization may mean that the machine learning model is pruned or otherwise simplified according to the capabilities of the third network node.
2) Obtaining, for example collecting or accessing, the second training data.
3) Cleaning the second training data and preparing the input to match the format defined by the LMF.
4) Selecting a cost function specific to the third network node, for example by using a variation of the generic cost function indicated by the LMF, or a cost function from a list of cost functions selected by the LMF.
5) Selecting the activation function(s) provided by the LMF to produce the output format defined by the LMF.
6) Performing the updating/training under the set of constraints indicated by the LMF.

In block 311, the third network node (type x NR-HU) transmits, to the LMF, a message indicative of the first updated machine learning model (type-x-GLoc) obtained by the third network node. The message may comprise the first updated machine learning model. Alternatively, the message may comprise an updated set of weights and biases associated with the first updated machine learning model. In other words, the refined process may be reported as a “delta” to the provided reference process, such that just the weights and biases that have been updated may be reported (i.e., without reporting the full model).

The message may be transmitted based on an estimated performance improvement of the updated machine learning model being above a threshold. In other words, the refined model may be reported if, when tested, it produces a performance improvement (compared to the original GLoc) larger than a given threshold. The threshold may be defined based on positioning accuracy and measurement granularity. This may reduce unnecessary reporting and therefore reduce network signaling.

In block 312, the fourth network node (type y NR-HU) obtains a second updated machine learning model by updating the machine learning model (i.e., the original GLoc) based on the third training data. The fourth network node may also validate the second updated machine learning model. The second updated machine learning model obtained by the fourth network node may be referred to as a type-y-GLoc. The fourth network node may perform the updating similarly as described above for block 310.

The third training data may comprise reference signal measurement information measured at the fourth network node from one or more received positioning reference signals (e.g., DL PRS, UL SRS, and/or SL PRS), wherein the fourth network node may be different to the one or more first network nodes and to the third network node. For example, the reference signal measurement information may comprise at least channel impulse response (CIR) measurements measured at the fourth network node from one or more received positioning reference signals.

In block 313, the fourth network node (type y NR-HU) transmits, to the LMF, a message indicative of the second updated machine learning model (type-y-GLoc) obtained by the fourth network node. The message may comprise the second updated machine learning model. Alternatively, the message may comprise an updated set of weights and biases associated with the second updated machine learning model.

In block 314, the LMF may validate or modify the first updated machine learning model and the second updated machine learning model. For example, prior to large-scale distribution, the LMF may cross-validate the updated model to ensure that it remains robust and performs within the target key performance indicators (KPIs). For example, the LMF may use stored test data to check that the updated model meets a given KPI target.

In block 315, the LMF transmits, or distributes, the first updated machine learning model (type-x-GLoc) to one or more second network nodes of type x. In other words, the LMF distributes the first updated machine learning model to other entities of the same type as the third network node (type x NR-HU). The one or more second network nodes may be referred to as type x units herein. The difference between the type x NR-HU and a type x unit is that the type x NR-HU has the ability to train the updated machine learning model, i.e., has the ability and computational resources to collect and label the second training data, and thus is designated to come up with an updated machine learning model that works well on all type x units.

A given second network node (type x unit) may be configured to use the first updated machine learning model (type-x-GLoc) for positioning a target UE. For example, if the type x unit is a gNB or anchor UE, then the type x unit may measure a reference signal received from the target UE to obtain, for example, CIR measurements. Alternatively, if the type x unit is the target UE, then the type x unit may measure a reference signal received from the gNB or anchor UE to obtain, for example, CIR measurements. The type x unit may then provide these measurements as input to the type-x-GLoc. The output of the type-x-GLoc may be a location estimate of the target UE. Alternatively, the output of the type-x-GLoc may be some other useful positioning-related information or intermediate features, such as time of arrival (TOA) and/or angle of arrival (AOA) of the (possible) line-of-sight (LOS) paths and/or strong non-line-of-sight (NLOS) paths.

The type-x-GLoc may be fed with the same input information and produce the same output type as the original GLoc. The difference is with the accuracy of these models, wherein the type-x-GLoc model may provide higher accuracy for a specific type of devices (i.e., for the type x units) compared to the original GLoc, because the type-x-GLoc model is refined based on the specific RF imperfections of this device type.

It should be noted that the LMF may also transmit the first updated machine learning model to other types of network nodes, for example to the one or more first network nodes.

In block 316, the LMF transmits, or distributes, the type-y-GLoc to one or more fifth network nodes of type y. In other words, the LMF distributes the second updated machine learning model to other entities of the same type as the fourth network node (type y NR-HU).

It should be noted that the LMF may also transmit the second updated machine learning model to other types of network nodes, for example to the one or more first network nodes.

Herein the terms “first network node”, “second network node”, etc. are used to distinguish the network nodes, and they do not necessarily mean specific identifiers of the network nodes.

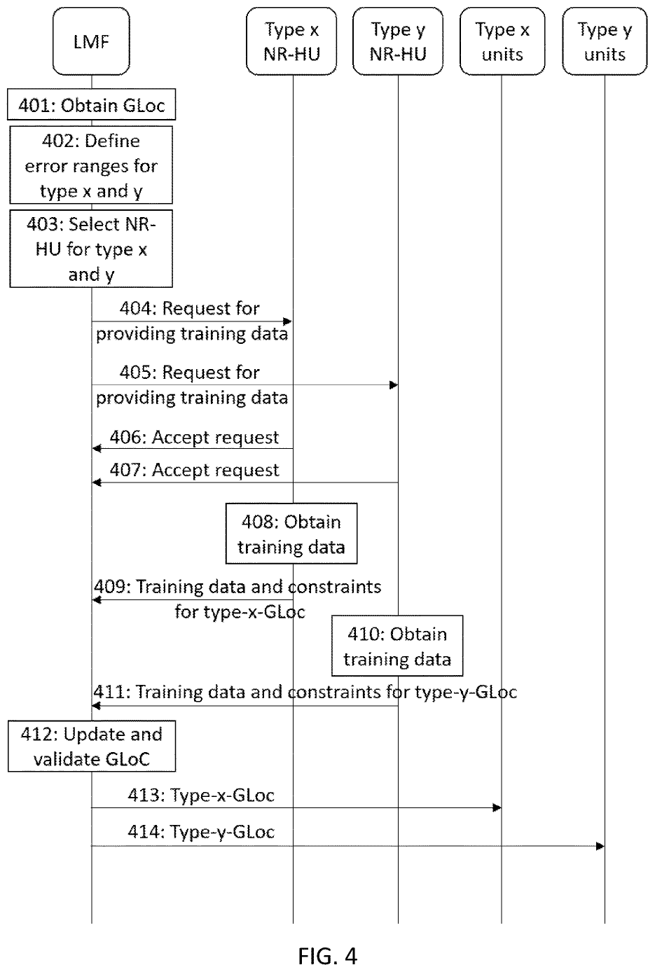

FIG. 4 illustrates a signaling diagram according to another example embodiment. In this example embodiment, the selected NR-HU collects and transfers its training data back to the LMF. Then, the LMF may aggregate data from multiple network nodes of the same type, store it in memory and produce the updated machine learning model. It should be noted that the LMF may also use the collected training data and combine it across different network node types to be used in updating the generic GLoc model.

Although two types (type x and type y) of network nodes are illustrated in FIG. 4, it should be noted the that the number of types may also be different than two. In other words, there may be one or more types of network nodes. In addition, the signaling procedure illustrated in FIG. 4 may be extended and applied according to the actual number of types. The central ML unit (e.g., LMF) may determine the actual number of types depending on the ability to group various network nodes based on their RF characteristics.

Referring to FIG. 4, in block 401, a central ML unit such as an LMF obtains a machine learning model for positioning, wherein the machine learning model is trained based on first training data related to one or more first network nodes. The machine learning model may be trained for positioning, or for a similar task that may also be used for positioning. The LMF may obtain the machine learning model by training the model at the LMF. Alternatively, the machine learning model may be trained at another entity, from which the LMF may receive the machine learning model. The machine learning model may be referred to as GLoc herein. For example, the machine learning model may comprise an artificial neural network (ANN). An example of an artificial neural network is illustrated in FIG. 10.

The first training data may comprise at least one of the following: reference signal measurement information measured at the one or more first network nodes from one or more received positioning reference signals (e.g., DL PRS, UL SRS, and/or SL PRS), emulated reference signal measurement information, or simulated reference signal measurement information related to the one or more first network nodes. For example, the reference signal measurement information may comprise at least channel impulse response (CIR) measurements, which may be simulated or measured at the one or more first network nodes from one or more received positioning reference signals. The emulated reference signal measurement information may be obtained, for example, by using emulation tools such as ray tracing, digital twin, etc.

The one or more first network nodes may comprise one or more types of network nodes. In one example, the one or more first network nodes may comprise a plurality of network nodes of different types.

In block 402, the LMF defines error ranges for type x and type y. The error ranges may indicate the internal timing errors that occurred during the measurement collection, due to RF imperfections or impairments. For example, a transmit timing error may indicate time delay from the time when the digital signal is generated at baseband to the time when the RF signal is transmitted from the transmit antenna. Receive timing error may indicate the time delay from the time when the RF signal arrives at the receive antenna to the time when the signal is digitized and time-stamped at the baseband. The error ranges may be defined by the LMF in order to classify the network nodes into type x and type y. For example, a type x host may be associated with an error range-x of +/−a ns, (e.g., a=5 ns).

In block 403, the LMF selects one or more third network nodes of type x (denoted as type x NR-HU), from which it will request training data to update/refine the machine learning model (generic GLoc) to take into account the RF imperfections specific to type x. The type of the one or more third network nodes may be different to the type of the one or more first network nodes.

The LMF may also select one or more fourth network nodes of type y (denoted as type y NR-HU), from which it will request training data to update/refine the machine learning model (generic GLoc) to take into account the RF imperfections specific to type y. Herein type y may refer to a type that is different to type x.

Herein the term “network node” may mean, for example, a target user device, a positioning reference unit, anchor UE, TRP, or an access node (e.g., gNB) of a radio access network.

Herein the term “type” may mean, for example, a vendor-specific user device, a vendor-specific access node (e.g., gNB), a TRP with certain RF characteristics, a user device with a certain number of receive antennas, an industrial internet of things (IIoT) device, a low-power high-accuracy positioning (LPHAP) device, a reduced capability (RedCap) device, a handheld user device, or a road-side unit (RSU). The type may be defined in relation to both the target positioning accuracy and the inherent error ranges that a given network node of that type is expected to introduce.

In block 404, the LMF transmits, to the one or more third network nodes (type x NR-HU), a request for providing second training data from the one or more third network nodes to the LMF for updating the machine learning model at the LMF. For example, the request may be transmitted in an information element of an LPP request message. A given third network node may accept or reject the request from the LMF based on the load condition and/or hardware limitations of the third network node.

In block 405, the LMF transmits, to the one or more fourth network nodes (type y NR-HU), a request for providing third training data from the one or more fourth network node to the LMF for updating the machine learning model at the LMF. For example, the request may be transmitted in an information element of an LPP request message. A given fourth network node may accept or reject the request from the LMF based on the load condition and/or hardware limitations of the fourth network node.

In block 406, the one or more third network nodes (type x NR-HU) transmit a response message to the LMF to accept the request. For example, the acceptance may be indicated in an information element of an LPP reply message comprising a yes or no flag.

In block 407, the one or more fourth network nodes (type y NR-HU) transmit a response message to the LMF to accept the request. For example, the acceptance may be indicated in an information element of an LPP reply message comprising a yes or no flag.

In block 408, the one or more third network nodes (type x NR-HU) obtain the second training data. For example, the one or more third network nodes may obtain the second training data by performing measurements, such as CIR measurements, on a received positioning reference signal, such as DL PRS, UL SRS, or SL PRS. Alternatively, the one or more third network nodes may obtain the second training data by retrieving stored measurements from memory. The one or more third network nodes may also clean the second training data prior to transmitting it to the LMF.

In block 409, the one or more third network nodes (type x NR-HU) transmit the second training data to the LMF. The LMF may store the received second training data in its memory. The one or more third network nodes may also transmit information indicative of a first set of constraints for updating the machine learning model at the LMF. For example, the first set of constraints may comprise a maximum supported depth (i.e., number of layers) of the artificial neural network, available activation functions, etc.

In block 410, the one or more fourth network nodes (type y NR-HU) obtain the third training data. For example, the one or more fourth network nodes may obtain the third training data by performing measurements, such as CIR measurements, on a received positioning reference signal, such as DL PRS, UL SRS, or SL PRS. Alternatively, the one or more fourth network nodes may obtain the third training data by retrieving stored measurements from memory. The one or more fourth network nodes may also clean the third training data prior to transmitting it to the LMF.

In block 411, the one or more fourth network nodes (type y NR-HU) transmit the third training data to the LMF. The LMF may store the received third training data in its memory. The one or more fourth network nodes may also transmit information indicative of a second set of constraints for updating the machine learning model at the LMF. For example, the second set of constraints may comprise a maximum supported depth (i.e., number of layers) of the artificial neural network, available activation functions, etc.

In block 412, the LMF obtains a first updated machine learning model (type-x-GLoc) by updating the machine learning model (the original GLoc) based at least partly on the second training data received from the one or more third network nodes.

The updating may comprise one or more of the followings steps 1-6:
1) Initializing the machine learning model using the original GLoc.
2) Accessing the second training data.
3) Cleaning the second training data and preparing the input to match the input format of the GLoc.
4) Selecting a cost function specific to the one or more third network nodes, for example by using a variation of the generic cost function of the GLoc.
5) Selecting the activation function(s) to produce the output format of the GLoc.
6) Performing the updating/training under the set of constraints indicated by the one or more third network nodes.

The LMF may also obtain a second updated machine learning model (type-y-GLoc) by updating the machine learning model (the original GLoc) based at least partly on the third training data received from the one or more fourth network nodes.

In block 413, the LMF transmits, or distributes, the first updated machine learning model (type-x-GLoc) to one or more second network nodes of type x. In other words, the LMF distributes the first updated machine learning model to other entities of the same type as the one or more third network nodes (type x NR-HU). The one or more second network nodes may be referred to as type x units herein. The difference between the type x NR-HU and a type x unit is that the type x NR-HU has the ability to train the updated machine learning model, i.e., has the ability and computational resources to collect and label the second training data, and thus is designated to come up with an updated machine learning model that works well on all type x units.

A given second network node (type x unit) may be configured to use the first updated machine learning model (type-x-GLoc) for positioning a target UE. For example, if the type x unit is a gNB or anchor UE, then the type x unit may measure a reference signal received from the target UE to obtain, for example, CIR measurements. Alternatively, if the type x unit is the target UE, then the type x unit may measure a reference signal received from the gNB or anchor UE to obtain, for example, CIR measurements. The type x unit may then provide these measurements as input to the type-x-GLoc. The output of the type-x-GLoc may be a location estimate of the target UE. Alternatively, the output of the type-x-GLoc may be some other useful positioning-related information or intermediate features, such as time of arrival (TOA) and/or angle of arrival (AOA) of the (possible) line-of-sight (LOS) paths and/or strong non-line-of-sight (NLOS) paths.

The type-x-GLoc may be fed with the same input information and produce the same output type as the original GLoc. The difference is with the accuracy of these models, wherein the type-x-GLoc model provides higher accuracy for a specific type of devices (i.e., for the type x devices) compared to the original GLoc, because the type-x-GLoc model is refined based on the specific RF imperfections of this device type.

It should be noted that the LMF may also transmit the first updated machine learning model to other types of network nodes, for example to the one or more first network nodes.

In block 414, the LMF transmits, or distributes, the type-y-GLoc to one or more fifth network nodes of type y. In other words, the LMF distributes the second updated machine learning model to other entities of the same type as the fourth network node (type y NR-HU). The one or more fifth network nodes may be referred to as type y units herein.

It should be noted that the LMF may also transmit the second updated machine learning model to other types of network nodes, for example to the one or more first network nodes.

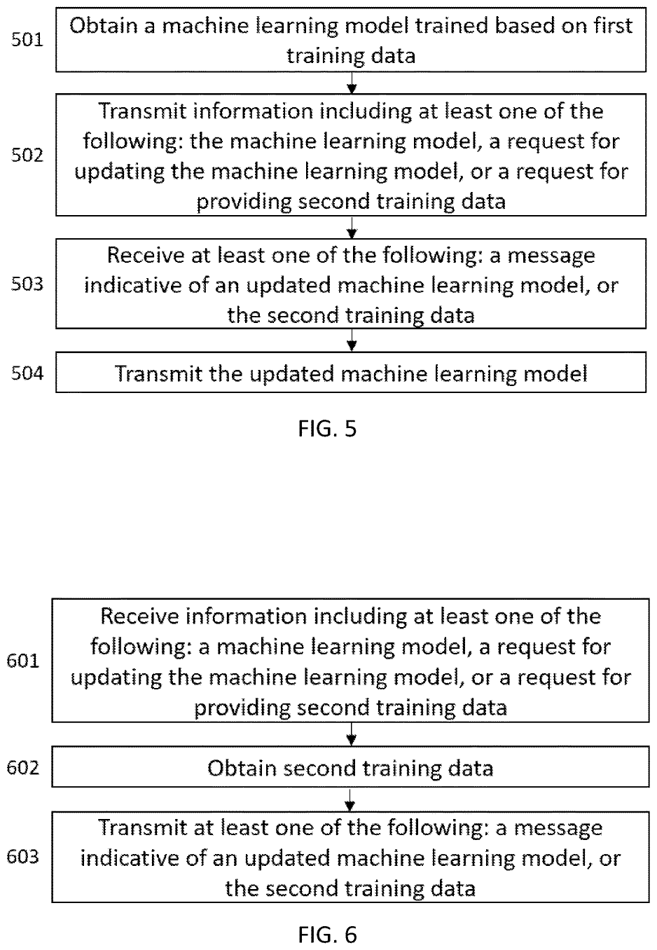

FIG. 5 illustrates a flow chart according to an example embodiment of a method performed by an apparatus such as, or comprising, or comprised in, a location management function (LMF) or a network data analytics function (NWDAF). For example, the apparatus may correspond to the LMF 112 of FIG. 1, or the LMF 212 of FIG. 2.

Referring to FIG. 5, in block 501, a machine learning model for positioning is obtained, wherein the machine learning model is trained based on first training data related to one or more first network nodes.

In block 502, information including at least one of the following is transmitted: the machine learning model, a request for updating the machine learning model based on second training data, or a request for providing the second training data for updating the machine learning model at the apparatus.

In block 503, at least one of the following is received: a message indicative of an updated machine learning model, or the second training data.

In block 504, the updated machine learning model is transmitted at least to one or more second network nodes.

FIG. 6 illustrates a flow chart according to an example embodiment of a method performed by an apparatus such as, or comprising, or comprised in, a network node. The network node may refer to, for example, a user device, a positioning reference unit, or an access node of a radio access network. For example, the network node may correspond to the UE 100, UE 102, or access node 104 of FIG. 1, or to the UE 200, any of the PRUs 202, 202A, 202B, or any of the access nodes 204, 204A, 204B of FIG. 2.

Referring to FIG. 6, in block 601, information including at least one of the following is received: a machine learning model for positioning, a request for updating the machine learning model at the apparatus based on second training data, or a request for providing the second training data for updating the machine learning model, wherein the machine learning model has been trained based on first training data related to one or more first network nodes.

In block 602, the second training data is obtained.

In block 603, at least one of the following is transmitted: a message indicative of an updated machine learning model, or the second training data.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The blocks, related functions, and information exchanges (messages) described above by means of FIGS. 3-6 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

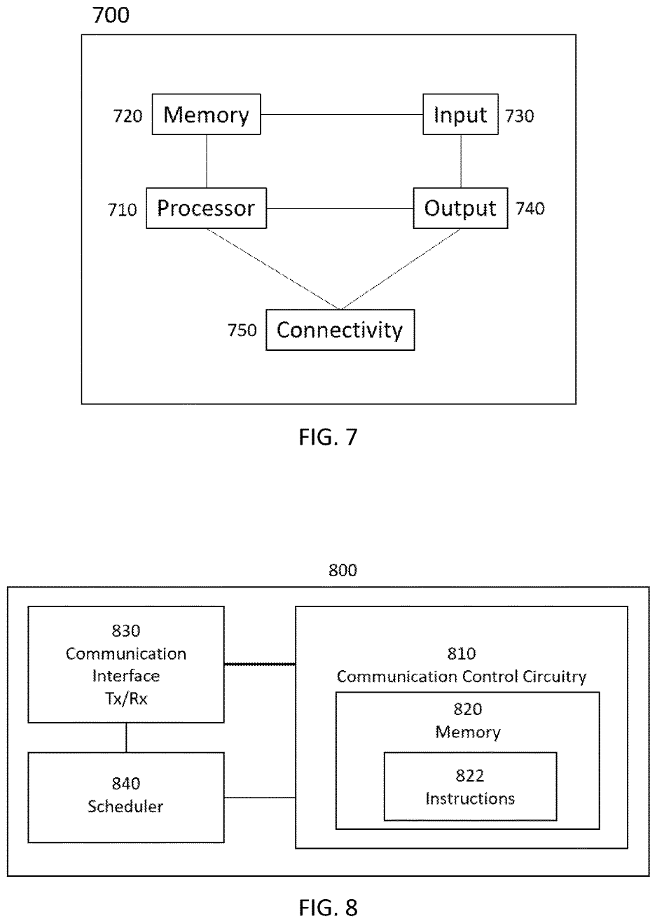

FIG. 7 illustrates an example of an apparatus 700 comprising means for performing any of the methods of FIGS. 3-6, or any other example embodiment described above. For example, the apparatus 700 may be an apparatus such as, or comprising, or comprised in, a user device. The user device may correspond to any of the user devices 100, 102 of FIG. 1, or to the user device 200 of FIG. 2, or to any of the PRUs 202, 202A, 202B of FIG. 2. The user device may also be called a subscriber unit, mobile station, remote terminal, access terminal, user terminal, terminal device, user equipment (UE), target UE, target user device, anchor UE, positioning reference unit (PRU), NR-HU, host, or network node.

The apparatus 700 comprises at least one processor 710. The at least one processor 710 interprets instructions (e.g., computer program instructions) and processes data. The at least one processor 710 may comprise one or more programmable processors. The at least one processor 710 may comprise programmable hardware with embedded firmware and may, alternatively or additionally, comprise one or more application-specific integrated circuits (ASICs).

The at least one processor 710 is coupled to at least one memory 720. The at least one processor is configured to read and write data to and from the at least one memory 720. The at least one memory 720 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 720 stores computer readable instructions that are executed by the at least one processor 710 to perform one or more of the example embodiments described above. For example, non-volatile memory stores the computer readable instructions, and the at least one processor 710 executes the instructions using volatile memory for temporary storage of data and/or instructions. The computer readable instructions may refer to computer program code.

The computer readable instructions may have been pre-stored to the at least one memory 720 or, alternatively or additionally, they may be received, by the apparatus, via an electromagnetic carrier signal and/or may be copied from a physical entity such as a computer program product. Execution of the computer readable instructions by the at least one processor 710 causes the apparatus 700 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 700 may further comprise, or be connected to, an input unit 730. The input unit 730 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 730 may comprise an interface to which external devices may connect to.

The apparatus 700 may also comprise an output unit 740. The output unit may comprise or be connected to one or more displays capable of rendering visual content, such as a light emitting diode (LED) display, a liquid crystal display (LCD) and/or a liquid crystal on silicon (LCoS) display. The output unit 740 may further comprise one or more audio outputs. The one or more audio outputs may be for example loudspeakers.

The apparatus 700 further comprises a connectivity unit 750. The connectivity unit 750 enables wireless connectivity to one or more external devices. The connectivity unit 750 comprises at least one transmitter and at least one receiver that may be integrated to the apparatus 700 or that the apparatus 700 may be connected to. The at least one transmitter comprises at least one transmission antenna, and the at least one receiver comprises at least one receiving antenna. The connectivity unit 750 may comprise an integrated circuit or a set of integrated circuits that provide the wireless communication capability for the apparatus 700. Alternatively, the wireless connectivity may be a hardwired application-specific integrated circuit (ASIC). The connectivity unit 750 may also provide means for performing at least some of the blocks of one or more example embodiments described above. The connectivity unit 750 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 700 may further comprise various components not illustrated in FIG. 7. The various components may be hardware components and/or software components.

FIG. 8 illustrates an example of an apparatus 800 comprising means for performing any of the methods of FIGS. 3-6, or any other example embodiment described above. For example, the apparatus 800 may be an apparatus such as, or comprising, or comprised in, an access node of a radio access network. The access node may correspond to the access node 104 of FIG. 1, or to any of the access nodes 204, 204A, 204B of FIG. 2. The apparatus 800 may also be referred to, for example, as a network node, a radio access network (RAN) node, a next generation radio access network (NG-RAN) node, a NodeB, an eNB, a gNB, a base transceiver station (BTS), a base station, an NR base station, a 5G base station, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 800 may comprise, for example, a circuitry or a chipset applicable for realizing one or more of the example embodiments described above. The apparatus 800 may be an electronic device comprising one or more electronic circuitries. The apparatus 800 may comprise a communication control circuitry 810 such as at least one processor, and at least one memory 820 storing instructions which, when executed by the at least one processor, cause the apparatus 800 to carry out one or more of the example embodiments described above. Such instructions 822 may, for example, include a computer program code (software) wherein the at least one memory and the computer program code (software) are configured, with the at least one processor, to cause the apparatus 800 to carry out one or more of the example embodiments described above. Herein computer program code may in turn refer to instructions which, when executed by the at least one processor, cause the apparatus 800 to perform one or more of the example embodiments described above. That is, the at least one processor and the at least one memory storing the instructions may provide the means for providing or causing the performance of any of the methods and/or blocks described above.

The processor is coupled to the memory 820. The processor is configured to read and write data to and from the memory 820. The memory 820 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 820 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 820 or, alternatively or additionally, they may be received, by the apparatus, via an electromagnetic carrier signal and/or may be copied from a physical entity such as a computer program product. Execution of the computer readable instructions causes the apparatus 800 to perform one or more of the functionalities described above.

The memory 820 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 800 may further comprise a communication interface 830 comprising hardware and/or software for realizing communication connectivity according to one or more communication protocols. The communication interface 830 comprises at least one transmitter (Tx) and at least one receiver (Rx) that may be integrated to the apparatus 800 or that the apparatus 800 may be connected to. The communication interface 830 may provide means for performing some of the blocks for one or more example embodiments described above. The communication interface 830 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 830 provides the apparatus with radio communication capabilities to communicate in the cellular communication system. The communication interface may, for example, provide a radio interface to one or more user devices. The apparatus 800 may further comprise another interface towards a core network such as the network coordinator apparatus or AMF, and/or to the access nodes of the cellular communication system.

The apparatus 800 may further comprise a scheduler 840 that is configured to allocate radio resources. The scheduler 840 may be configured along with the communication control circuitry 810 or it may be separately configured.

It is to be noted that the apparatus 800 may further comprise various components not illustrated in FIG. 8. The various components may be hardware components and/or software components.

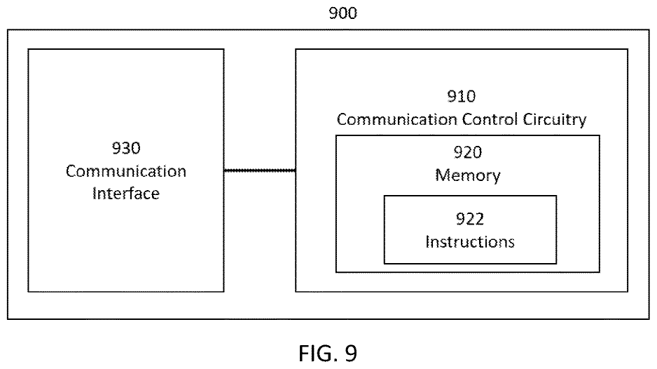

FIG. 9 illustrates an example of an apparatus 900 comprising means for performing any of the methods of FIGS. 3-6, or any other example embodiment described above. For example, the apparatus 900 may be an apparatus such as, or comprising, or comprised in, a central ML unit. The central ML unit may also be referred to, for example, as a location management function (LMF), a location server, or a network data analytics function (NWDAF). For example, the central ML unit may correspond to the LMF 112 of FIG. 1, or to the LMF 212 of FIG. 2.

The apparatus 900 may comprise, for example, a circuitry or a chipset applicable for realizing one or more of the example embodiments described above. The apparatus 900 may be an electronic device comprising one or more electronic circuitries. The apparatus 900 may comprise a communication control circuitry 910 such as at least one processor, and at least one memory 920 storing instructions which, when executed by the at least one processor, cause the apparatus 900 to carry out one or more of the example embodiments described above. Such instructions 922 may, for example, include a computer program code (software) wherein the at least one memory and the computer program code (software) are configured, with the at least one processor, to cause the apparatus 900 to carry out one or more of the example embodiments described above. Herein computer program code may in turn refer to instructions which, when executed by the at least one processor, cause the apparatus 900 to perform one or more of the example embodiments described above. That is, the at least one processor and the at least one memory storing the instructions may provide the means for providing or causing the performance of any of the methods and/or blocks described above.

The processor is coupled to the memory 920. The processor is configured to read and write data to and from the memory 920. The memory 920 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 920 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

The memory 920 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 900 may further comprise a communication interface 930 comprising hardware and/or software for realizing communication connectivity according to one or more communication protocols. The communication interface 930 comprises at least one transmitter (Tx) and at least one receiver (Rx) that may be integrated to the apparatus 900 or that the apparatus 900 may be connected to. The communication interface 930 may provide means for performing some of the blocks for one or more example embodiments described above. The communication interface 930 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 930 provides the apparatus with radio communication capabilities to communicate in the cellular communication system. The communication interface may, for example, provide a radio interface to one or more user devices. The apparatus 900 may further comprise another interface towards a core network such as the network coordinator apparatus or AMF, and/or to the access nodes of the cellular communication system.

It is to be noted that the apparatus 900 may further comprise various components not illustrated in FIG. 9. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

FIG. 10 illustrates an example of an artificial neural network 1030 with one hidden layer 1002, and FIG. 11 illustrates an example of a computational node 1004. However, it should be noted that the artificial neural network 1030 may also comprise more than one hidden layer 1002.

An artificial neural network (ANN) 1030 comprises a set of rules that are designed to execute tasks such as regression, classification, clustering, and pattern recognition. The ANN may achieve such objectives with a learning/training procedure, where they are shown various examples of input data, along with the desired output. This way, the ANN learns to identify the proper output for any input within the training data manifold. Learning/training by using labels is called supervised learning and learning without labels is called unsupervised learning. Deep learning may require a large amount of input data.

Deep learning (also known as deep structured learning or hierarchical learning) is part of a broader family of machine learning methods based on the layers used in the artificial neural network. A deep neural network (DNN) 1030 is an artificial neural network comprising multiple hidden layers 1002 between the input layer 1000 and the output layer 1014. Training of DNN allows it to find the correct mathematical manipulation to transform the input into the proper output, even when the relationship is highly non-linear and/or complicated.

A given hidden layer 1002 comprises nodes 1004, 1006, 1008, 1010, 1012, where the computation takes place. As shown in FIG. 11, a given node 1004 combines input data 1000 with a set of coefficients, or weights 1100, that either amplify or dampen that input 1000, thereby assigning significance to inputs 1000 with regard to the task that the algorithm is trying to learn. The input-weight products are added 1102 and the sum is passed through an activation function 1104, to determine whether and to what extent that signal should progress further through the neural network 1030 to affect the ultimate outcome, such as an act of classification. In the process, the neural network learns to recognize correlations between certain relevant features and optimal results.

In the case of classification, the output of a DNN 1030 may be considered as a likelihood of a particular outcome. In this case, the number of layers 1002 may vary proportional to the number of the used input data 1000. However, when the number of input data 1000 is high, the accuracy of the outcome 1014 is more reliable. On the other hand, when there are fewer layers 1002, the computation might take less time and thereby reduce the latency. However, this highly depends on the specific DNN architecture and/or the computational resources available.

Initial weights 1100 of the model can be set in various alternative ways. During the training phase, they may be adapted to improve the accuracy of the process based on analyzing errors in decision-making. Training a model is basically a trial-and-error activity. In principle, a given node 1004, 1006, 1008, 1010, 1012 of the neural network 1030 makes a decision (input*weight) and then compares this decision to collected data to find out the difference to the collected data. In other words, it determines the error, based on which the weights 1100 are adjusted. Thus, the training of the model may be considered a corrective feedback loop.

For example, a neural network model may be trained using a stochastic gradient descent optimization algorithm, for which the gradients are calculated using the backpropagation algorithm. The gradient descent algorithm seeks to change the weights 1100, so that the next evaluation reduces the error, meaning that the optimization algorithm is navigating down the gradient (or slope) of error. It is also possible to use any other suitable optimization algorithm, if it provides sufficiently accurate weights 1100. Consequently, the trained parameters of the neural network 1030 may comprise the weights 1100.

In the context of an optimization algorithm, the function used to evaluate a candidate solution (i.e., a set of weights) is referred to as the objective function. With neural networks, where the target is to minimize the error, the objective function may be referred to as a cost function or a loss function. In adjusting weights 1100, any suitable method may be used as a loss function. Some examples of a loss function are mean squared error (MSE), maximum likelihood estimation (MLE), and cross entropy.

As for the activation function 1104 of the node 1004, it defines the output 1014 of that node 1004 given an input or set of inputs 1000. The node 1004 calculates a weighted sum of inputs, perhaps adds a bias, and then makes a decision as “activate” or “not activate” based on a decision threshold as a binary activation or using an activation function 1104 that gives a nonlinear decision function. Any suitable activation function 1104 may be used, for example sigmoid, rectified linear unit (ReLU), normalized exponential function (softmax), sotfplus, tanh, etc. In deep learning, the activation function 1104 may be set at the layer level and applies to all neurons (nodes) in that layer. The output 1014 is then used as input for the next node and so on until a desired solution to the original problem is found.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1-31. (canceled)

32. An apparatus comprising at least one processor, and at least one memory storing instructions which, when executed by the at least one processor, cause the apparatus at least to:
obtain a machine learning model for positioning, wherein the machine learning model is trained based on first training data related to one or more first network nodes;
transmit information including at least one of the following: the machine learning model, a request for updating the machine learning model based on second training data, or a request for providing the second training data for updating the machine learning model at the apparatus;
receive at least one of the following: a message indicative of an updated machine learning model, or the second training data; and
transmit the updated machine learning model at least to one or more second network nodes.

33. The apparatus according to claim 32, further being caused to:
select a third network node, wherein the information is transmitted to the third network node, and
wherein a type of the third network node is different to a type of the one or more first network nodes, and a type of the one or more second network nodes correspond to the type of the third network node.

34. The apparatus according to claim 32, further being caused to:
validate or modify the updated machine learning model prior to transmitting the updated machine learning model to the one or more second network nodes.

35. The apparatus according to claim 32, further being caused to:
transmit a set of constraints for updating the machine learning model.

36. The apparatus according to claim 32, further being caused to:
transmit information on a reference training procedure for updating the machine learning model, wherein the information on the reference training procedure comprises at least a set of parameters used for structuring the reference training procedure.

37. The apparatus according to claim 32, wherein the message comprises the updated machine learning model.

38. The apparatus according to claim 32, wherein the message comprises an updated set of weights and biases associated with the updated machine learning model.

39. A method comprising:
obtaining, by an apparatus, a machine learning model for positioning, wherein the machine learning model is trained based on first training data related to one or more first network nodes;
transmitting, by the apparatus, information including at least one of the following: the machine learning model, a request for updating the machine learning model based on second training data, or a request for providing the second training data for updating the machine learning model at the apparatus;
receiving, by the apparatus, at least one of the following: a message indicative of an updated machine learning model, or the second training data; and
transmitting, by the apparatus, the updated machine learning model at least to one or more second network nodes.

40. The method according to claim 39, further comprising:
selecting a third network node, wherein the information is transmitted to the third network node, and
wherein a type of the third network node is different to a type of the one or more first network nodes, and a type of the one or more second network nodes correspond to the type of the third network node.

41. The method according to claim 39, further comprising:
validating or modifying the updated machine learning model prior to transmitting the updated machine learning model to the one or more second network nodes.

42. The method according to claim 39, further comprising:
transmitting a set of constraints for updating the machine learning model.

43. The method according to claim 39, further comprising:
transmitting information on a reference training procedure for updating the machine learning model, wherein the information on the reference training procedure comprises at least a set of parameters used for structuring the reference training procedure.

44. The method according to claim 39, wherein the message comprises the updated machine learning model.

45. The method according to claim 39, wherein the message comprises an updated set of weights and biases associated with the updated machine learning model.

46. A non-transitory computer readable medium comprising program instructions which, when executed by an apparatus, cause the apparatus to perform at least the following:
obtaining a machine learning model for positioning, wherein the machine learning model is trained based on first training data related to one or more first network nodes;
transmitting information including at least one of the following: the machine learning model, a request for updating the machine learning model based on second training data, or a request for providing the second training data for updating the machine learning model at the apparatus;
receiving at least one of the following: a message indicative of an updated machine learning model, or the second training data; and
transmitting the updated machine learning model at least to one or more second network nodes.

47. The non-transitory computer readable medium according to claim 46, wherein the apparatus is further caused to perform:
selecting a third network node, wherein the information is transmitted to the third network node, and
wherein a type of the third network node is different to a type of the one or more first network nodes, and a type of the one or more second network nodes correspond to the type of the third network node.

48. The non-transitory computer readable medium according to claim 46, wherein the apparatus is further caused to perform:
validating or modifying the updated machine learning model prior to transmitting the updated machine learning model to the one or more second network nodes.

49. The non-transitory computer readable medium according to claim 46, wherein the apparatus is further caused to perform:
transmitting a set of constraints for updating the machine learning model.

50. The non-transitory computer readable medium according to claim 46, wherein the apparatus is further caused to perform:
transmitting information on a reference training procedure for updating the machine learning model, wherein the information on the reference training procedure comprises at least a set of parameters used for structuring the reference training procedure.

51. The non-transitory computer readable medium according to claim 46, wherein the message comprises the updated machine learning model.
